(19) United States
(12) Patent Application Publication
(10) Pub. No.: US 2024/0377057 A1
(43) Pub. Date: Nov. 14, 2024

(54) HAND-HELD POWER TOOL COMPRISING A LIGHT EMITTING UNIT AND LIGHT EMITTING UNIT FOR SUCH A POWER TOOL

(71) Applicant: Andrea VALENTINI, Milano (IT)

(72) Inventor: Andrea VALENTINI, Milano (IT)

(21) Appl. No.: 18/640,320

(22) Filed: Apr. 19, 2024

(30) Foreign Application Priority Data
May 9, 2023 (EP) 23 172 386.7

(51) Int. Cl. F21V 33/00; B24B 23/02; B25F 5/02

(52) U.S. Cl. CPC F21V 33/0084; B25F 5/02; B24B 23/02

(57) ABSTRACT

A hand-held power tool (10) features a tool housing (12) and a motor (24) located therein and a tool shaft (36) comprising a rotational axis (40), actuated by the motor (24), a working element (38) attached to a distal end of the tool shaft (36) and performing a working movement about the rotational axis (40) of the tool shaft (36), and a light emitting unit (100) releasably attached to the tool housing (12) in order to illuminate a working area (102) which the working element (38) works during intended use of the power tool (10). The light emitting unit (100) comprises a light source (104), a switching element (108) for switching the light emitting unit (100) between a turned-on condition and a turned-off condition, an energy storage device (110) for storing electric energy and supplying the electric energy to the light source (104) when the light emitting unit (100) is in its turned-on condition, and an external casing (112), in which the light source (104), the switching element (108) and the energy storage device (110) is located, wherein the light emitting unit (100) is operable as a self-sufficient unit after detachment and removal from the tool housing (12), in order to illuminate areas outside the working area (102) of the working element (38) and/or to illuminate the working area (102) from other incidence directions or angles differing from the point of view of the user during intended use of the power tool (10).

### BACKGROUND OF THE INVENTION

### Field Of Invention

The present invention refers to a hand-held power tool comprising a tool housing and a motor located therein and a tool shaft having a rotational axis, actuated by the motor when in operation in order to make the tool shaft perform a rotational movement about its rotational axis. Further the power tool comprises a working element attached to a distal end of the tool shaft and performing a working movement about the rotational axis of the tool shaft during operation of the motor, and a light emitting unit releasably attached to the tool housing in order to illuminate a working area which the working element works during intended use of the power tool.

Further, the invention refers to a light emitting unit comprising at least one light source adapted for emitting light, a switching element adapted for switching the light emitting unit between a turned-on condition, in which the at least one light source emits light, and a turned-off condition, in which the at least one light source does not emit light, an energy storage device adapted for storing electric energy and for supplying the electric energy to the at least one light source, when the light emitting unit is in its turned-on condition, and an external casing, in which the at least one light source is located in a manner as to emit light towards an area outside the external casing, and in which the switching element is located in a manner operable from outside the external casing by a user. The light emitting unit is operable as a self-sufficient unit.

### Prior Art

A hand-held power tool of the above-identified kind is known, for instance, from US 2008/122 302 A1. This prior art discloses a pneumatic power tool comprising an electricity generator for generating electric energy from moving parts of the pneumatic power tool and for supplying electric components of the power tool with the electric energy generated during operation of the pneumatic power tool. The electric components may comprise a light emitting unit releasably attached to the tool housing in order to illuminate a working area which the working element works during intended use of the power tool. The light emitting unit comprises one or more light sources but no energy storage device for electric energy. Electric energy for the operation of the light sources is provided directly from the power tool's generator through a conductive tool housing. To this end, the removably attachable light emitting unit not only has to be mechanically attached to the power tool but also electrically connected to the power tool. Furthermore, after detachment and removal of the light emitting unit from the power tool, it no longer works because it is no longer supplied with electric energy.

The light emitting unit known from US 2008/122 302 A1 can illuminate the working area during the intended use of the power tool only from a direction and an incident angle corresponding more or less to the view direction and view angle of the user of the power tool. This may be sufficient in the case of a pneumatic wrench, but with other power tools and in other situations it may be desirable to illuminate the working area from other directions and/or other angles. For instance, when polishing or sanding a working area with a polishing or sanding power tool smears and scratches as well as bumps and irregularities in the surface to be polished or sanded can be seen much easier and clearer by the user if the light strikes the working area from a direction and/or an angle different from the user's view direction and view angle during intended use of the power tool. Smears and scratches as well as bumps and irregularities in the surface to be polished or sanded can be seen much easier and clearer by the user if the light strikes the working area in a direction essentially opposite to the user's view direction during intended use of the power tool.

Of course, this could be achieved by the power tool known from US 2008/122 302 A1 by lifting the power tool from the working area while still keeping the pneumatic motor running, in order to continue to generate electric energy for the operation of the light emitting unit, to rotate the power tool about an essentially vertical axis by approximately 180° and to hold the power tool with the front facing the user in a distance to the user's body. In this way, the working area may be illuminated with light from the light emitting unit of the power tool in a direction essentially opposite to the view direction of the user onto the working area. However, this is obviously very strenuous and energy-sapping, not to mention the dangers for the user due to the power tool continuing to run in order to generate the electric energy to operate the light emitting unit.

On the other hand, self-sufficient light emitting units in the form of torches are known in the art. These comprise an external casing with one or more light sources, a battery located in the casing and a switching element for selectively turning on and off the light sources. These torches are either hand-held by a user or they can be attached by means of an elastic belt or strap to a handlebar of a bicycle or the like. When attached to the handlebar of a bicycle or the like, the light emitting units are equipped with a respective adapter element corresponding to the cylindrical shape of a handlebar section and located between the external casing of the light emitting unit and the handle bar.

These known torches or headlights for bicycles have several disadvantages: Due to the bright light required when using the torches as bicycle headlights, they are rather large, heavy and bulky. This is no problem as long as they are attached to a handlebar of a bicycle of the like. However, attachment of such torches to power tools for illuminating a working area during intended use of the power tool, would result in a bulkier, heavier and particular misbalanced power tool with most of its weight resting on the front of the power tool and possibly also to larger vibrations to which the user of the power tool would be exposed. Furthermore, the vibrations created in power tools, in particular orbital polishing and sanding power tools, during their intended use, places particularly high demands on a possible attachment of a light emitting unit to the tool housing, which cannot be met by the known belts or straps and the adapter elements. Due to the strong vibrations during intended use of power tools, particularly strong and vibration resistant connections for a light emitting unit to the tool housing are required.

Another disadvantage of the known light emitting units is that, once they have been attached to the tool housing in one way or another, they often appear as extraneous bodies on the tool housing, since the shape of the external casing is usually not adapted in any way to the external shape of the tool housing. This is not only disadvantageous from an aesthetic point of view, but also from a practical point of view, as the light emitting unit attached to the tool housing makes the power tool locally much heavier and larger, so that it is difficult to reach narrow and angled areas for working with the working element.

Finally, it is emphasized that light emitting units for illuminating a working area of a power tool, in particular of a polishing or sanding power tool, are very particular devices. They are specifically designed for this special application in terms of size and manageability of the light emitting unit, brightness and colour of the emitted light, and shape of the emitted light beam. These requirements cannot be fulfilled by the known bicycle headlights or the like.

### SUMMARY OF THE INVENTION

Starting from the prior art described above, it is an object of the present invention to improve known power tools such that they have a light emitting unit configured to illuminate a working area of the working element of the power tool when attached to the tool housing, which can be detached and removed from the tool housing and can be used as a self-sufficient unit after detachment and removal from the tool housing.

In order to solve this object, a power tool comprising the combination of features of claim 1 is suggested. In particular, starting from the hand-held power tool of the above identified kind, it is suggested that the light emitting unit comprises:

at least one light source adapted for emitting light towards the working area when the light emitting unit is attached to the tool housing,
a switching element adapted for switching the light emitting unit between a turned-on condition, in which the at least one light source emits light, and a turned-off condition, in which the at least one light source does not emit light, an energy storage device adapted for storing electric energy and for supplying the electric energy to the at least one light source when the light emitting unit is in its turned-on condition, and
an external casing, in which the at least one light source is located in a manner as to emit light towards the working area when the light emitting unit is attached to the tool housing, in which the switching element is located in a manner operable from outside the external casing by a user of the power tool when the light emitting unit is attached to the tool housing and in which the energy storage device is located,
wherein the light emitting unit is operable as a self-sufficient unit after detachment and removal from the tool housing, in order to illuminate areas outside the working area of the working element and/or to illuminate the working area from other incidence directions and angles differing from the point of view of the user of the power tool during intended use of the power tool. Preferably, the removed light emitting unit is held and guided by the user of the power tool in order to illuminate the desired areas in the desired direction and angle.

The light emitting unit emits an essentially white light to illuminate the working area of the working element or any other desired surface area close to the working area. When attached to the tool housing, the light emitting unit illuminates the working area in an illuminating direction and angle essentially corresponding to the view direction and angle of a user of the power tool during intended use of the power tool. When attached to the tool housing, the energy storage device may the charged with current from the power tool, either directly through electric contacts or contactless, e.g., by means of inductive or capacitive charging or the like. When attached to the tool housing, the entire external casing of the light emitting unit or the at least one light source or optical elements positioned in the light path between the at least one light source and the illuminated working area may be adjusted in order to direct the light beam emitted by the light emitting unit exactly to a desired region in or close to the working area. When attached to the tool housing, the cross-sectional form of the emitted light beam may be adjusted to a desired form. Furthermore, it is also conceivable that the light emitting unit is adapted to change the intensity and/or the colour of the emitted light.

The light emitting unit may be easily detached and removed from the tool housing by the user of the power tool. In particular, the light emitting unit may be detached by the user even if he is wearing working gloves. To this end, it is suggested that the user grasps the external casing of the light emitting unit, thereby automatically releasing a releasable connection between the external casing and the tool housing. The user can then hold and guide the light emitting unit in his hand and illuminate the working area or desired other areas near the working area in a direction and/or angle different from the user's view direction and angle during intended use of the power tool. In particular, the user can easily bring the light emitting unit into a position and orientation such that it illuminates the working area in a direction essentially opposite to the user's view direction during intended use of the power tool. In particular, smears and scratches as well as bumps and irregularities in a surface to be polished or sanded can be seen much easier and clearer by the user if the light strikes the working area or any desired other area near the working area in a direction essentially opposite to the user's view direction during intended use of the power tool.

Due to the energy storage device located inside the external casing of the light emitting unit, the at least one light source will emit light even for an extended period of time after separation from the power tool. The user can calmly examine the working area and consider possible measures to remedy inadequacies in the working area or in the surface to be polished or sanded, respectively.

The light emitting unit is relatively small and light weight, in order to allow working with the power tool in tight and angled spaces even after attachment of the light emitting unit to the tool housing. Furthermore, this assures that work with the power tool is not more difficult for the user due to higher weight and locally larger dimensions caused by the light emitting unit attached to the tool housing.

Preferably, in the case of a hand-held or mobile polishing or sanding power tool, the working element may correspond to two main types. A first type of working element comprises an eccentric element and a backing pad. The backing pad has a bottom surface configured for releasable attachment of a sanding or polishing member thereto. A top surface of the backing pad comprises a cylindrical pin which is held in the eccentric element in a manner freely rotatable about a second rotational axis of the cylindrical pin extending essentially parallel to the rotational axis of the tool shaft and in a distance thereto. Opposite to the backing pad, the eccentric element comprises an attachment region with which the eccentric element may be attached to the tool shaft, preferably in a torque proof manner, i.e., a torque about the rotational axis can be transmitted from the tool shaft to the eccentric element. The attachment region may comprise a cylindrical pin for inserting into a bore provided in a distal end of the tool shaft or it may comprise a recess for receipt of a distal end of the tool shaft.

A second type of working element comprises only a backing pad having a bottom surface configured for releasable attachment of a sanding or polishing member thereto. A top surface of the backing pad comprises an attachment region with which the backing pad may be attached to the tool shaft, preferably in a torque proof manner, i.e., a torque about the rotational axis can be transmitted from the tool shaft to the backing pad. The attachment region may comprise a cylindrical pin for inserting into a bore provided in a distal end of the tool shaft or it may comprise a recess for receipt of a distal end of the tool shaft.

It is suggested that the at least one light source comprises a light emitting diode (LED) or any other type of semiconductor light source. The advantage of such light sources is their rather long service life and their rather low energy consumption. LEDs are available in large numbers with different physical and optical characteristics. In particular, there is a wide range of available LEDs with different operation voltages and currents, light intensities and light colours available at rather low costs. When one or more LEDs are used as light sources, the light emitting unit also comprises an operating device (ballast) or driver.

In an LED, the current can only flow in one direction (diode). When heated, the current and thus the power consumption in the LED can increase, which leads to further heating. Therefore, an efficient cooling of the light emitting unit is recommendable.

It is conceivable, that the light emitting unit uses a cooling air stream generated inside the tool housing for cooling components of the power tool during its intended use. To this end, it may be possible, that air outlet openings provided in the tool housing are located near or under the external casing of the light emitting unit attached to the tool housing. The cooling air stream leaving the tool housing through the air outlet openings may sweep along the external casing and/or it may enter into the external casing through respective air inlet openings provided in the external casing. These air inlet openings could even be provided on a side of the external casing facing the tool housing when the light emitting unit is attached to the tool housing.

Additionally or alternatively, the energy storage device may comprise a battery, preferably a rechargeable battery. One or more conventional batteries may be located in a receptacle within the external casing. The receptacle may be closed with a receptacle cover. The batteries may be extracted from the receptacle, possibly after opening the receptacle cover, and replaced by new batteries. One or more rechargeable batteries may also be provided in such a receptacle and replaced by fully charged batteries if desired. Alternatively, the external casing can be provided with a socket element to which an electrical charger may be attached for charging the batteries in the receptacle.

When the light emitting unit is releasably attached to the tool housing, charging of the batteries could also be accomplished by means of electric energy from the power tool. Charging of the batteries may be effected through electric contacts or contactless, e.g., by means of inductive or capacitive charging or the like. To this end, respective inductive or capacitive charging components are provided in the tool housing and in the external casing of the light emitting unit.

It is further suggested that the external casing of the light emitting unit is made of a plastic material. The plastic material is strong and robust enough to withstand the hard work of power tools, in particular of polishing or grinding machines. Further, the plastic material is good at absorbing shocks or impacts, so damage to the light emitting unit and its external casing, respectively, can be prevented. In addition, the plastic material is resistant to moisture, acidic substances, etc.

Additionally or alternatively, the external casing of the light emitting unit may be shaped in correspondence to a part of the tool housing in order to realize a releasable attachment of the light emitting unit to the tool housing by means of a form fit connection between the external casing of the light emitting unit and that part of the tool housing to which the external casing of the light emitting unit is attached. To this end, the external casing of the light emitting unit may be clamped and matingly locked into an aligning position on the tool housing via the specific semi-rigid structure of the external casing or part thereof. The external casing or part thereof may be formed in a cuff- or sleeve-style. The cuffs or sleeves may enclose at least part of the tool housing and, due to the elasticity of the material of the cuffs or sleeves, hold on to the tool housing by themselves by clinging or clamping thereto.

In particular, it is suggested that the light emitting unit is attached to a front part of the tool housing. For example, in the case of an angular polishing or sanding machine, the front part is considered to be near that part of the housing where the rotational axis of the tool shaft intersects with a longitudinal axis of a motor shaft or an intermediary shaft located between the motor shaft and the tool shaft.

According to a preferred embodiment, when the light emitting unit is attached to the tool housing, a contact surface of the external casing of the light emitting unit is in full contact with an external surface of the tool housing. This preferably means that the entire contact surface of the external casing lies fully on a correspondingly designed surface of the tool housing. This assures a steady and firm attachment of the light emitting unit to the tool housing. Preferably, the contact surface has a three-dimensional extension. When the contact surfaces of the external casing of the light emitting unit and of the tool housing enter into mutual contact, the position of the light emitting unit in respect to the tool housing is defined in at least two planes extending perpendicular to each other, for instance in an xy-plane and an xz-plane of a cartesian coordinate system. Preferably, the contact surfaces are designed such that the position of the light emitting unit in respect to the tool housing is defined in all three planes extending perpendicular to each other, when the contact surfaces of the external casing of the light emitting unit and of the tool housing enter into mutual contact.

According to another preferred embodiment, it is suggested that the releasable attachment of the light emitting unit to the tool housing is realized by means of a snap-action connection between the external casing of the light emitting unit and the tool housing. Alternatively or additionally, the releasable attachment of the light emitting unit to the tool housing is realized by means of interacting magnetic elements provided in or on the external casing of the light emitting unit and in or on the tool housing. The magnetic elements may comprise one or more permanent magnets and/or one or more ferromagnetic elements.

According to yet another preferred embodiment, it is suggested that the three-dimensional form of the external casing of the light emitting unit is adapted to the outer shape of a part of the tool housing to which the light emitting unit is releasable attachable in such a manner that the external casing of the light emitting unit is flush with the adjacent surface of the tool housing when the light emitting unit is attached to the tool housing. For instance, the front part of the tool housing may have an indentation, an inward bulge or a recess. At least part of the external casing of the light emitting unit fits into that indentation, bulge or recess. The walls of the external casing merge into the adjacent surface of the tool housing without steps and preferably also without kinks.

It is further suggested that the light emitting unit comprises an acceleration sensor configured to sense vibrations of the power tool and to determine an operation state of the power tool depending on the magnitude of the sensed vibrations, when the light emitting unit is attached to the tool housing. In particular, the sensor can be configured to detect a turned-on condition and/or a turned-off condition of the power tool. Despite attempts to reduce or even compensate vibrations during intended use of the power tool, operation of the tool motor and rotation of the working element about the rotational axis of the tool shaft will inevitably lead to some kind of vibration which is also transferred to and can be sensed at the tool housing. Preferably, at least one threshold value for the vibrations/accelerations is defined, and the power tool is considered to be in the turned-on condition if the vibrations/accelerations exceed the threshold value and to be in the turned-off condition if the vibrations/accelerations are below the threshold value. Determination of the operation state can be effected with a time delay after the vibrations/accelerations exceeding or falling below the threshold value. Furthermore, the sensed vibrations/accelerations can be filtered and the determination of the operation state can be effected based on the filtered values.

The determined operation state of the power tool can be used for many different tasks, including assessment of proper functioning of the power tool, mounting of a correct backing pad and/or polishing or sanding member, or the like. The light emitting unit may be configured to automatically actuate the switching element in order to switch the light emitting unit between the turned-on condition and the turned-off condition, depending on the magnitude of the sensed vibrations. Thus, the sensed vibrations/accelerations and/or the determined operation state of the power tool may be used for turning on or off the at least one light source of the light emitting unit. This has the advantage that the working area is automatically illuminated upon activation and intended use of the power tool. Then, after turning off the power tool, the illumination of the working area is also interrupted or stopped. Activation and/or deactivation of the light sources can be effected with a time delay after the vibrations/accelerations exceeding or falling below the threshold value.

Finally, it is suggested that the light emitting unit comprises a radio communication device configured to transmit radio signals representative of an operation state of the power tool. The radio signals may be received from external or remote components, for instance a dust suction device or vacuum cleaner, which is used for aspiring dust laden air from a sanding power tool. Upon receipt of a radio signal from the light emitting unit indicating of an activation of the power tool, the dust suction device is automatically turned on. A suction hose of the dust suction device may be attached to a suction opening of the sanding power tool so that dust laden air from the working area of the sanding power tool is aspired. Similarly, when the power tool is turned off again, the suction device receives a respective radio signal and is automatically turned off. Turning off the suction device is preferably effected with a time delay in respect to the receipt of the respective radio signal indicating the turning off of the power tool. The radio signal and the data contained therein may be in any communication standard known today or yet to be developed, including WiFi, BlueTooth, ZigBee or the like.

Further features and advantages of the present invention will become apparent from the embodiments described hereinafter with reference to one or more of the accompanying drawings. It is emphasized that each of the features shown in the figures and possibly described hereinafter with reference to a certain embodiment may be important to the invention on its own or in the context of another embodiment even if not explicitly shown in the figures and/or described in the subsequent description.

### BRIEF DESCRIPTION OF THE DRAWING

The drawing includes FIGS. 1-6 that show the following:

FIG. 1 is a side view of a power tool according to the present invention according to a preferred embodiment;

FIG. 2 is a top view of the power tool of FIG. 1;

FIG. 3 is a tool head of a power tool according to the present invention according to another preferred embodiment in a vertical cross-sectional view;

FIG. 4 is a tool head of a power tool according to the present invention according to another preferred embodiment in a perspective side view;

FIG. 5 is a tool head of a power tool according to the present invention according to another preferred embodiment in a perspective front view; and

FIG. 6 is a tool head of a power tool according to the present invention according to yet another preferred embodiment in a vertical cross-sectional view.

### DETAILED DESCRIPTION OF THE INVENTION

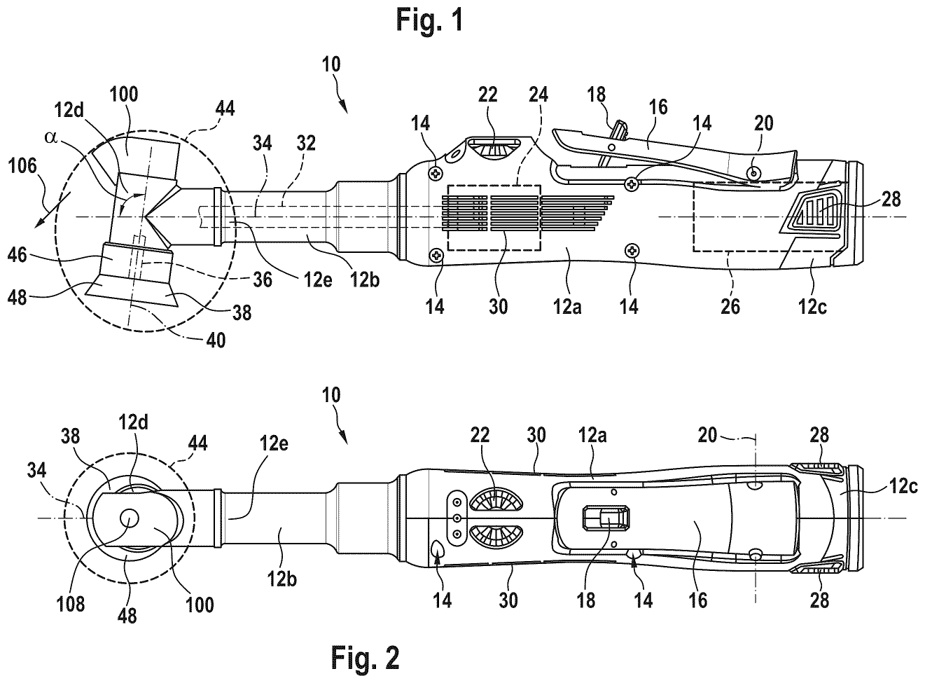

FIGS. 1 and 2 show a side view and a top view, respectively, of a hand held and/or hand guided power tool 10 embodied as a polishing machine or as a polisher. Alternatively, the power tool 10 according to the present invention could also be embodied as a sander or a grinder, or even as a drill, or a cordless screw driver only to mention a few examples.

The polisher 10 comprises a housing 12 made up of essentially two main parts, a rear part 12a and a front part 12b. In more detail the housing 12 comprises the rear part 12a, a distal end part 12c, the front part 12b and a front casing 12d. The rear part 12a is preferably made of a rigid plastics material. Of course, the rear part 12a of the housing 12 could also be made of a different rigid material, for example metal or carbon fibre. Further, the rear part 12a of the housing 12 could comprise regions provided with resilient material like a soft plastic material or rubber in order to ensure safe and comfortable gripping, holding and guiding of the power tool 10 by a user. The rear part 12a of the housing 12 is preferably divided by means of an essentially vertical plain into two half shells which are attached on one another along the vertical plane and held together by screws 14.

The rear part 12a of the housing 12 comprises an actuation lever 16 co-operating with a switch (not shown), preferably located inside the housing 12, for turning on and off the polisher 10. The actuation lever 16 may comprise a blocking mechanism 18 for avoiding unintentional activation of the tool 10. The actuation lever 16 is rotatable about a rotational axis 20 extending perpendicular in respect to a longitudinal extension of the housing 12. In the embodiment shown in FIGS. 1 and 2, the actuation lever 16 is located on a top side of the housing 12. Of course, it would also be possible to locate the lever 16 on a bottom side of the housing 12. It is also conceivable, to use one or more push buttons or a rotary switch instead of the lever 16 to turn the power tool 10 on and off.

Furthermore, in the embodiment of FIGS. 1 and 2 the rear part 12a of the housing 12 is provided with a turn wheel 22 for speed regulation of a tool's motor 24. The rotary wheel 22 may co-operate with a potentiometer (not shown), preferably located inside the housing 12. Of course, it is also conceivable, to provide the actuation lever 16 or the one or more push buttons or the rotary switch with a combination of functionalities for turning on and off the motor 24 and for regulating the speed of the motor 24. In that case the turn wheel 22 could be omitted. Furthermore, the turn wheel 22 could be provided on a lateral side of the housing 12 instead of on the top side as shown in FIGS. 1 and 2.

A distal rear end 12c of the rear part 12a can be removed from the rest of the housing 12 in order to withdraw a battery 26 from the inside of the rear part 12a of the housing 12. The battery 26 provides the polisher 10 and its electronic components with electric energy for their operation. Of course, the polisher 10 could also be operated with electric energy from a mains power supply. In that case the battery 26 would not be necessary and the receptacle for the battery 26 in the housing 12 could be used for accommodating a transformer and other electric circuitry for transforming the mains voltage (e.g., 100V or 250V AC and 50Hz or 60Hz) into an operating voltage (e.g., 12V, 18V, or 24V DC) for the electronic components of the polisher 10.

The distal end 12c of the housing 12 may be secured to the rear part 12a by means of a snap-action connection comprising two opposite lateral snap-releasing knobs 28 for releasing the snap-action connection. For removing the distal rear end 12c from the rear part 12a of the housing 12, the lateral snap-releasing knobs 28 are pressed, thereby releasing the snap-action connection and allowing separation of the distal end 12c of the housing 12 from the rear part 12a and withdrawal of the battery 26 from the housing 12. The distal end 12c of the housing 12 may be fixedly attached to the battery 26 or it may be in the form of a separate lid for closing the receptacle for the battery 26 independently.

The rear part 12a of the housing 12 may be provided with a plurality of cooling vents 30 of any desired shape and extension enabling an airstream from the inside of the housing 12 into the environment and cooling of the electronic components located inside the housing 12 during operation of the power tool 10.

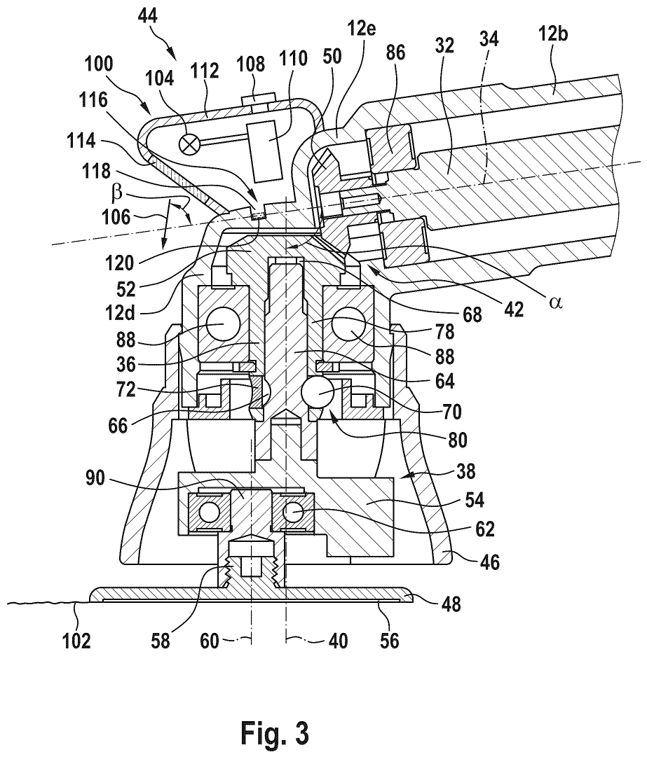

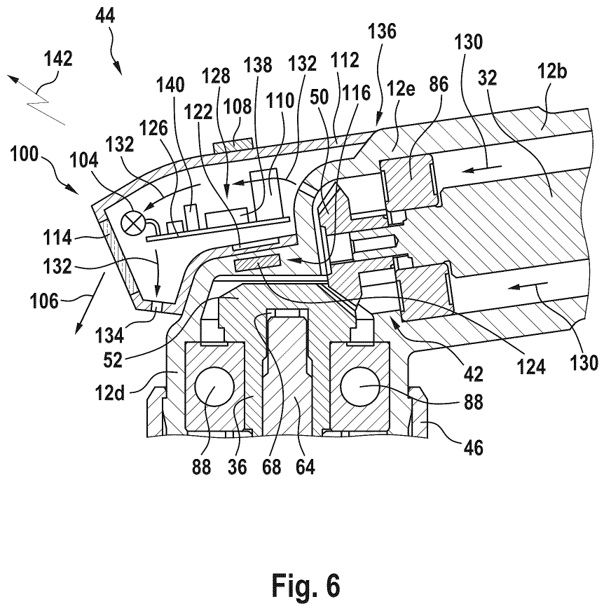

The front part 12b of the housing 12 is essentially tube-shaped and serves for receiving and guiding a driving shaft 32, e.g., by means of one or more bearings 86 (see FIGS. 3 and 6), during its rotation about a rotational axis 34. The driving shaft 32 is driven by the motor 24. To this end, the driving shaft 32 may form an integral part with a motor shaft or may be attached thereto in a torque-proof manner. The tube-shaped front part 12b is preferably made of a metal, e.g., aluminium, or a rigid plastic material. Preferably, the front part 12b has a circular cross-sectional shape. The front part 12b may be releasably attached to the rear part 12a of the housing 12, e.g., by means of a threaded connection or by screws. It is also conceivable to simply sandwich a rear end of the front part 12b between the two half shells which form the rear part 12a of the housing 12. By fixing the two half shells together, e.g., by means of the screws 14, the front part 12b may be held and fixed in respect to the rear part 12a of the housing 12. Alternatively, the front part 12b forms an integral part with the rear part 12a. In particular, it is conceivable that the front part 12b also comprises two half shells which each may form an integral part with the respective half shells of the rear part 12a of the housing 12. In that case, the front part 12b is made of the same material as the rear part 12a of the housing 12.

Located inside the rear part 12a of the housing 12 is the electric motor 24, which is preferably embodied as a brushless (BL) motor, in particular a BL direct current (BLDC) motor. Furthermore, located between the motor shaft and the driving shaft 32, there may be a first gear mechanism (not shown) which can set a certain transmission ratio between the rotational speed of the motor shaft and the rotational speed of the driving shaft 32. Depending on the design of the gear mechanism, the ratio can be 1, larger than 1 or smaller than 1. Usually, the ratio will be larger than 1 in order to reduce the rotational speed of the driving shaft 32 in respect to the rotational speed of the motor shaft and to increase the torque which the driving shaft 32 can supply.

The power tool 10 may comprise a second gear mechanism 42 (see FIGS. 3 and 6), which may be provided for translating the rotational movement of the driving shaft 32 about the rotational axis 34 into a rotational movement of a tool shaft 36 of the power tool 10 about a further rotational axis 40. The two rotational axes 34, 40 intersect at a certain angle a between approximately 70° and 110°, in particular around 90°. In the embodiment of FIGS. 1 and 2, the angle a of the two rotational axes 34, 40 is approximately 98°. The tool shaft 36 actuates a working element 38 of the power tool 10.

A front end of the driving shaft 32, the second gear mechanism 42 and the tool shaft 36 are preferably located in a tool head 44 which is attached to a front end 12e of the front part 12b of the tool housing 12. The tool head 44 preferably comprises a tube-like front casing 12d which serves for receiving and guiding the tool shaft 36, e.g., by means of one or more bearings 88 (see FIGS. 3 and 6), during its rotation about the rotational axis 40. The front casing 12d may have a circular cross-sectional form. A diameter of the circle of the circular cross-sectional form of the front casing 12d is preferably essentially the same as the diameter of the circle of the circular cross-sectional form of the front part 12b. The tool head 44 or the front casing 12d, respectively, is preferably an integral part of the front part 12b of the housing 12. It is preferably made of the same material as the tube-like front part 12b. A protective shroud 46 is attached to a bottom end of the tube-like front casing 12d surrounding at least part of the working element 38, for instance an eccentric element 54 (see FIGS. 3 and 6) or an extension rod (not shown), interconnecting a distal end of the tool shaft 36 with a backing pad 48 of the working element 38.

As can be seen in FIGS. 3 and 6, the second gear mechanism 42 may comprise a bevel gear arrangement with two meshing bevel gear wheels 50, 52. One bevel gear wheel 50 may be attached to the driving shaft 32 or form an integral part therewith. The other bevel gear wheel 52 may be attached to the tool shaft 36 or form an integral part therewith. The bevel gear arrangement 42 could comprise a transmission ratio of larger than 1, smaller than 1 or equal to 1.

In contrast to what has been described above, the first and second gear mechanism could also be designed as a single gear mechanism located in the front part 12b between the motor shaft and the driving shaft 32 or in the tool head 44 between the driving shaft 32 and the tool shaft 36. In that case, the single gear mechanism preferably has a transmission ration of ≠1. Alternatively, the power tool 10 according to the present invention may also comprise no gear mechanism at all, in which case the tool shaft 36 would rotate about the same rotational axis as the motor shaft and—if present—the driving shaft 32.

Furthermore, a printed circuit board (PCB) comprising electric and electronic circuitry and components which together form at least part of a control unit may be located inside the housing 12. Preferably, the control unit comprises a microcontroller and/or a microprocessor for processing a computer program which is programmed to perform the desired motor control function, when it is processed on the microprocessor.

In contrast to what has been described above, the power tool 10 could also be equipped with a pneumatic motor instead of the electric motor 24. In that case, pressurized air could be fed to the power tool 10 through an air inlet and supplied to the pneumatic motor through appropriate piping or tubing.

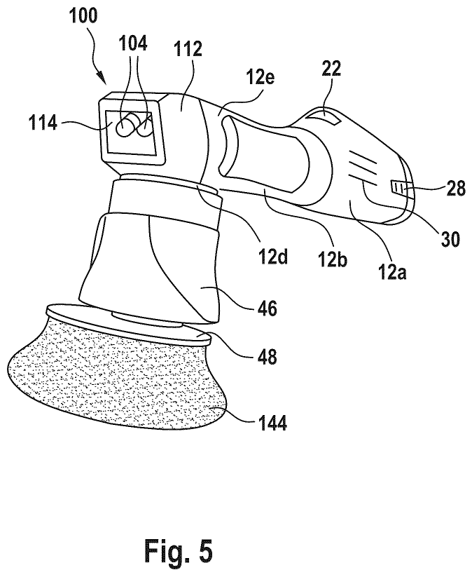

As can be further seen in FIGS. 3 and 6, a first type of working element 38 may comprise an eccentric element 54 and a backing pad 48. The backing pad 48 has a bottom surface 56 configured for releasable attachment of a sanding or polishing member 144 (see FIG. 5) thereto, e.g., by means of a Velcro® attachment. A sanding member may comprise a paper, fabric or a plastic foil with abrasive particles embedded in its bottom surface and a corresponding attachment layer on its top surface for releasable attachment to the bottom surface 56 of the backing pad 48. A polishing member may comprise a pad having a bottom surface comprising a sponge or foam material, natural or synthetic wool, microfibre or the like and a corresponding attachment layer on its top surface for releasable attachment to the bottom surface 56 of the backing pad 48.

A top surface of the backing pad 48 comprises a cylindrical pin 58 which is held in the eccentric element 54 in a manner freely rotatable about a rotational axis 60 of the cylindrical pin 58 by means of a bearing 62. The rotational axis 60 extends essentially parallel to the rotational axis 40 of the tool shaft 36 and in a distance thereto. In the embodiments shown in FIGS. 3 and 6, a spindle 90 is held in the bearing 62 in a manner freely rotatable about the rotational axis 60. The cylindrical pin 58 is attached to a distal end of the spindle 90, for instance by means of a threaded connection. Thus, in FIGS. 3 and 6, the cylindrical pin 58 is indirectly held in the bearing 62 by means of the spindle 90. However, it is also conceivable that the cylindrical pin 58 forms an integral part of the spindle 90, in which case the backing pad 48 would be directly held in the bearing 62. The backing pad 48 is preferably made of a rigid plastic material, metal or the like.

Opposite to the backing pad 48, the eccentric element 54 comprises a further cylindrical pin 64 having at least one radial recess 66 on its external circumferential surface. The further cylindrical pin 64 may be designed separate from the eccentric element 54 and attached thereto in a torque-proof manner, e.g., by means of a threaded connection, a press fit connection, welding or the like. In the context of the invention “torque proof” means that a torque can be transmitted from the further cylindrical pin 64 to the eccentric element 54. However, it is also conceivable that the further cylindrical pin 64 forms an integral part of the eccentric element 54. The further cylindrical pin 64 is preferably made of a ferromagnetic material, e.g., steel or any other suitable metal, or a rigid plastic material. The eccentric element 54 may also be made of metal or a rigid plastic material.

A second type of working element, which is not shown in the figures, may comprise only a backing pad 48 having a bottom surface 56 configured for releasable attachment of a sanding or polishing member thereto. A top surface of the backing pad 48 comprises a cylindrical pin 58 having at least one radial recess on its external circumferential surface. The cylindrical pin 58 is preferably made of a ferromagnetic material, e.g., steel or any other suitable metal, or of a plastic material. In that case the eccentric element is omitted and the backing pad 48 is directly attached to the distal end of the tool shaft 36. The cylindrical pin 58 would preferably have a longer axial extension than the pin 58 shown in FIGS. 3 and 6. The cylindrical pin 58 would form some kind of extension rod. Alternatively, a separate extension rod could be arranged between the distal end of the tool shaft 36 and the cylindrical pin 58.

In the embodiments shown in FIGS. 3 and 6, the tool shaft 36 has an axial bore 68 for receiving the further cylindrical pin 64 of the first type of working element 38 or the cylindrical pin 58 of the second type of working element 38. The bore 68 is radially delimited by means of a hollow cylindrical jacket 78 making an integral part of the tool shaft 36. At least one locking element 70 may be held in the hollow cylindrical jacket 78 in a manner movable in a radial direction. In FIGS. 3 and 6 only one locking element 70 on the right of the rotational axis 40 is shown, whereas another locking element on the left has been omitted in order to allow easier understanding of the design and functioning of the axial holding arrangement 80. In particular, on the left of the rotational axis 40, where the other locking element 70 would be located, a holding receptacle 72 for the other locking element 70 is visible. The holding receptacle 72 has a radial extension in order to allow movement of the locking element 70 in the radial direction. Furthermore, the holding receptacle 72 may be designed such that the locking elements 70 will not fall out when the cylindrical pin 58 or the further cylindrical pin 64 of the working element 38 is removed from the bore 68.

In an alternative embodiment, the cylindrical pin 58 or the further cylindrical pin 64 of the working element 38 could have an axial bore into which the tool shaft 36 could be introduced in an axial direction.

Generally speaking, the power tool 10 according to FIGS. 3 and 6 has an axial holding arrangement 80 configured to hold the working element 38 in respect to the tool shaft 36, when the working element 38 is releasably attached to the tool shaft 36 from outside the tool housing 12 in an axial direction extending parallel to the rotational axis 40 of the tool shaft 36. However, other types of attachment and holding of the working element 38 at the distal end of the tool shaft 36 are conceivable, too, may they at present be known or not.

The at least one locking element 70 on the one hand or the cylindrical pin 58 or the further cylindrical pin 64 in and/or around the at least one radial recess 66 on the other hand is made of a magnetic material. The other one of the at least one locking element 70 or the cylindrical pin 58, 64 in and/or around the at least one radial recess 66 is made of a magnetic material or a ferromagnetic material. This leads to a magnetic interaction between the at least one locking element 70 and the at least one radial recess 66. The at least one locking element 70 is automatically held in its locking position and in the at least one radial recess 66 by magnetic force, thereby mechanically engaging with the at least one radial recess 66, when the working element 38 is attached to the tool shaft 36, thereby holding the working element 38 in respect to the tool shaft 36 in the axial direction.

The axial holding arrangement 80 may comprise a discrete radial recess 66 for each of the locking elements 70, each of the radial recesses 66 configured to receive the respective locking element 70 when in its locking position. Alternatively, the axial holding arrangement 80 may comprise a single annularly shaped radial recess 66 which is configured to receive all of the locking elements 70 when in their locking positions.

The locking elements 70 may have a spherical form. However, other forms, e.g., a cuboid form, are conceivable, too. The at least one radial recess has a radial cross-sectional form corresponding to the form of the locking elements 70.

In order to provide for an even distribution of the holding forces acting between the tool shaft 36 and the working element 38, it is suggested that the axial holding arrangement 80 comprises at least two, preferably at least three, particularly preferred at least four locking elements 70 equidistantly positioned in a circumferential direction about the rotational axis 40 of the tool shaft 36, when the working element 36 is attached to the tool shaft 38.

In contrast to what is shown in the figures, instead of moving and holding the locking elements 70 in their locking positions and in the at least one recess 66 by radially acting magnetic force, the locking elements 70 could also be moved and held in their locking positions and in the at least one recess 66 by radially acting mechanical force, exerted for instance by one or more spring elements and/or an external annular element movable in the axial direction between at least two positions, similar to what is described in US 2011/036 604 A1. In a first position of the external annular element, the locking elements 70 are forced and held in their locking positions and in the at least one radial recess 66 if the working element 38 has been attached to the tool shaft 36 in the axial direction. In that position of the external annular element, the working element 38 is held in the axial direction in respect to the tool shaft 36. In a second position of the external annular element, the locking elements 70 are free to move radially and to leave their locking positions and the at least one radial recess 66. In that position of the external annular element, the working element 38 is no longer held in the axial direction in respect to the tool shaft 36 and free to be removed from the tool shaft 36 and the power tool 10.

Depending on how the working element 38 is designed and attached to the distal end of the tool shaft 36, the working element 38 may perform different working movements, comprising a rotational, a random-orbital (see FIG. 3), a gear-driven or an orbital working movement. If the working element 38 comprises a backing pad 48 only, which is directly attached to the tool shaft 36, it will perform a rotational movement. If in FIG. 3 the free rotation of the backing pad 48 in respect to the eccentric element 54 is restricted or even prevented, the backing pad 48 will perform an orbital working movement. A gear-driven working movement may be achieved if the working element 38 comprises a gear arrangement located between the distal end of the tool shaft 36 and the backing pad 48, for instance a planetary gear arrangement. In a gear-driven movement the number of rotations of the backing pad 48 about its rotational axis 60 depends on and is a fixed ratio of the rotations of the tool shaft about its rotational axis 40.

The hand-held power tool 10 according to the present invention comprises a light emitting unit 100 releasably attached to the tool housing 12 in order to illuminate a working area 102 which the working element 38 works during intended use of the power tool 10.

In particular, it is suggested that the light emitting unit 100 comprises: at least one light source 104 adapted for emitting light in a direction 106 towards the working area 102 when the light emitting unit 100 is attached to the tool housing 12,

a switching element 108 adapted for switching the light emitting unit 100 between a turned-on condition, in which the at least one light source 104 emits light, and a turned-off condition, in which the at least one light source 104 does not emit light,
an energy storage device 110 adapted for storing electric energy and for supplying the electric energy to the at least one light source 104 when the light emitting unit 100 is in its turned-on condition, and
an external casing 112, in which the at least one light source 104 is located in a manner as to emit light towards the working area 102 when the light emitting unit 100 is attached to the tool housing 12, in which the switching element 108 is located in a manner operable from outside the external casing 112 by a user of the power tool 10 when the light emitting unit 100 is attached to the tool housing 12 and in which the energy storage device 110 is located.

The light emitting unit 100 is operable as a self-sufficient unit after detachment and removal from the tool housing 12, in order to illuminate surface areas outside the working area 102 of the working element 38 and/or to illuminate the working area 102 from other incidence directions and angles from the power tool user's point of view, when the light emitting unit 100 is hand-held and hand-guided by the user of the power tool 10.

For attachment of the light emitting unit 100 to the tool housing 12, the tool housing 12 may be provided with a recess (not shown) adapted for receiving at least part of the external casing 112 of the light emitting unit 100. Seen along a direction of insertion of the light emitting unit 100 into the recess, the recess may have the same shape as that part of the external casing 112 being received by the recess. In particular, the recess and/or of that part of the external casing 112 being received by the recess has a dome-shaped, rectangular or square shape, with sloping or vertical side walls. The light emitting unit 100 may be held in the recess by means of a snap-in connection, by frictional force or in any other manner. To this end, it is suggested, that the external casing 112 or at least that part of the tool housing 12 comprising the recess is made of a resilient material, e.g., an elastic plastic material, rubber or the like.

The light emitting unit 100 emits an essentially white light to illuminate the working area 102 of the working element 38 or any other desired surface area close to the working area 102. When attached to the tool housing 12, the light emitting unit 100 illuminates the working area 38 in an illuminating direction 106 and angle essentially corresponding to the view direction and angle of a user of the power tool 10 during intended use of the power tool 10.

When attached to the tool housing 12, the energy storage device 110 may the charged with current from the power tool 10, either directly through electric contacts or contactless, e.g., by means of inductive or capacitive charging or the like. When attached to the tool housing 12, the entire external casing 112 of the light emitting unit 100 or the at least one light source 104 or an optical element 114 positioned in the light path between the at least one light source 104 and the illuminated working area 102 may be adjusted in order to direct a light beam emitted by the light emitting unit 100 exactly to a desired region in or close to the working area 102. When attached to the tool housing 12, the cross-sectional form of the emitted light beam may be adjusted to a desired form. Furthermore, it is also conceivable that the light emitting unit 100 is adapted to change the intensity and/or the colour of the emitted light.

The at least one light source 104 may comprise a light emitting diode (LED) or any other type of semiconductor light source. The advantage of such light sources 104 is their rather long service life and their rather low energy consumption as well as their compact design. When one or more LEDs are used as light sources 104, the light emitting unit 100 preferably also comprises an operating device (ballast) or driver. The driver may comprise various electric and/or electronic components as well as possibly also a microprocessor or microcontroller. These components 128 are placed on a printed circuit board (PCB) 126 (see FIG. 6). The components 128 may be mounted on the PCB 126. A plurality of conductive tracks may be formed on the PCB 126, which interconnect the components 128. The at least one light source 104 is preferably in contact with the conductive tracks on the PCB 126 and with the other components 128 attached thereto. The energy storage device 110 may be electrically connected to the other components 128 and the at least one light source 104 through the conductive tracks. To this end, the energy storage device 110 may be mounted (fixedly attached and electrically contacted) on the PCB 126.

The energy storage device 110 may comprise a battery, preferably a rechargeable battery. One or more conventional batteries may be located in a receptacle within the external casing 112. The receptacle may be closed with a receptacle cover. The batteries may be extracted from the receptacle, possibly after opening the receptacle cover, and replaced by new batteries. One or more rechargeable batteries may also be provided in such a receptacle and replaced by fully charged batteries if desired. Alternatively, the external casing 112 can be provided with a socket element to which an electrical charger may be attached for charging an internal battery.

When the light emitting unit 100 is releasably attached to the tool housing 12, charging of the battery could also be accomplished by means of electric energy from the power tool 10. Charging of the battery may be effected through electric contacts or contactless, e.g., by means of inductive or capacitive charging or the like. To this end, respective inductive or capacitive charging components are provided in the tool housing 12 and in the external casing 112 of the light emitting unit 100, in particular at positions located opposite to each other when the light emitting unit 100 is attached to the tool housing 12.

The external casing 112 of the light emitting unit 100 is preferably made of a plastic material, in particular an opaque plastic material. The external casing 112 may comprise a light exit window through which light from the at least one light source 104 passes on its way to the illuminated surface area 102. The light exit window may be closed by means of a transparent or translucent lens cover 114. The lens cover 114 may be provided with optical elements, e.g., comprising prisms, cylinder lenses or the like, in order to deflect light passing through the lens cover 114. The optical elements may focus and direct the light passing through towards the surface area 102 to be illuminated. Thus, the lens cover 114 may constitute an optical element 114 in the light path. Alternatively, the lens cover 114 may be designed without any optical elements. Further optical elements may be positioned in the light path, e.g., between the at least one light source 104 and the lens cover 114. For instance, the at least one light source 104 may be associated with an optical lens which bundles and focuses the light rays emitted by the LEDs into a 180° half-space and directs them onto the light exit window.

The light emitting unit 100 is attached to a surface of the tool housing 12, preferably a top surface of the front casing 12d, extending essentially parallel to a longitudinal extension of the front part 12b and to a rotational axis of the motor shaft and the driving shaft 32. In respect to the extension of that top surface, the light emission direction 106 extends at a rather large angle of larger 45° (see FIG. 3), preferably of larger 60°, particularly preferred of larger 75°.

The light emitting unit 100 is releasably attached to the tool housing 12 by means of a releasable connection 116 between the external casing 112 and the tool housing 12. In the embodiment of FIG. 3, the releasable connection 116 comprises a snap-action or latching connection between the external casing 112 of the light emitting unit 100 and the tool housing 12. To this end, the external casing 112 may comprise a spring tongue 118 with a latching element 120 directed towards the tool housing 12, which can engage in a hole or recess provided in the tool housing 12, in particular the front casing 12d of the tool housing 12, when the light emitting unit 100 is placed on the tool housing 12. Alternatively, the hole or recess could also be provided in the front end 12e of the tool housing 12. Alternatively, in FIG. 6, the releasable connection 116 comprises a magnetic connection between the external casing 112 of the light emitting unit 100 and the tool housing 12. To this end, a first magnetic element 122 may be associated with the external casing 112 and a second magnetic element 124 may be associated with the tool housing 12, in particular with the front casing 12d of the tool housing 12, when the light emitting unit 100 is placed on the tool housing 12. Alternatively, the second magnetic element 124 could also be associated with the front end 12e of the tool housing 12. The releasable attachment 116 may comprise one or more permanent magnets in or on the external casing 112 and in or on the tool housing 12. Alternatively, the releasable attachment 116 may comprise one or more permanent magnets in or on the external casing 112 or in or on the tool housing 12 and one or more ferromagnetic elements in or on the other one of the external casing 112 and the tool housing 12.

Other possible ways for realizing the releasable attachment of the light emitting unit 100 to the tool housing 12 are conceivable, too. For example, the external casing 112 of the light emitting unit 100 could be shaped in correspondence to a part of the tool housing 12 in order to realize a releasable attachment of the light emitting unit 100 to that part of the tool housing 12 by means of a form fit connection between the external casing 112 and that part of the tool housing 12. To this end, the external casing 112 may be clamped and locked in a mating manner into an aligning position on the tool housing 12 via a specific semi-rigid structure of the external casing 112 or part thereof. The external casing 112 or part thereof may be formed in a cuff- or sleeve-style. The cuff or sleeve may enclose at least part of the tool housing 12 and, due to the elasticity of the material of the cuff or sleeve, hold on to the tool housing 12 by itself by clinging or clamping thereto.

After removal from the tool housing 12, the user can hold and guide the light emitting unit 100 in his hand and illuminate the working area 102 or desired other areas near the working area 102 in a direction 106 and/or angle different from the user's view direction and angle during intended use of the power tool 10. In particular, the user can easily bring the light emitting unit 100 into a position and orientation such that it illuminates the working area 102 in a direction 106 essentially opposite to the user's view direction during intended use of the power tool 10. Smears and scratches as well as bumps and irregularities in a surface 102 to be polished or sanded can be seen much easier and clearer by the user if the light strikes the working area 102 or any desired other area near the working area 102 in a direction 106 essentially opposite to the user's view direction during intended use of the power tool 10.

Due to the energy storage device 110 located inside the external casing 112 of the light emitting unit 100, the at least one light source 104 will emit light even for an extended period of time after separation from the power tool 10. The user can calmly examine the working area 102 and consider possible measures to remedy inadequacies in the working area 102 or in the surface to be polished or sanded, respectively.

In an LED, the current can only flow in one direction (diode). With rising operation temperature of an LED, the current and thus the power consumption in the LED can increase, which leads to further heating. Therefore, an efficient cooling of the light emitting unit 100, in particular of the components inside the external casing 112, is recommendable.

The light emitting unit 100 may use a cooling air stream 130 generated inside the tool housing 12 for cooling components of the power tool 10 during its intended use. This are stream 130 may be guided into the inside of the external casing 112 and used as a cooling airstream 132 for the components 128 of the light emitting unit 100 including the at least one light source 104 and the energy storage device 110. To this end, one or more air outlet openings 134 may be provided in the tool housing 12 near or under the external casing 112 of the light emitting unit 100 when attached to the tool housing 12. The cooling air stream 130 leaving the tool housing 12 through the air outlet opening 134 may sweep along an outer surface of the external casing 112 and/or it may enter into the external casing 112 through respective air inlet openings provided in the external casing 112. In the embodiment of FIG. 6, the air inlet opening is provided by the fact that the external casing 112 has no wall facing the front end 12e of the tool housing 12. Alternatively, if the external casing 112 had a wall facing the front end 12e, the air inlet opening could be provided in the wall in correspondence with the air outlet opening 134 of the tool housing 12. The air inlet opening is provided on a side of the external casing 112 facing the tool housing 12 when the light emitting unit 100 is attached to the tool housing 12.

Preferably, the light emitting unit 100 is attached to a front part of the tool housing 12 or to the tool head 44, respectively. For example, in the case of an angular polishing or sanding machine, like the power tool 10 shown in the figures, the front part is considered to be near that part of the tool housing 12 where the rotational axis 40 of the tool shaft 36 intersects with a longitudinal axis 34 of a motor shaft or an intermediary shaft, e.g., the drive shaft 32, located between the motor shaft and the tool shaft 36.

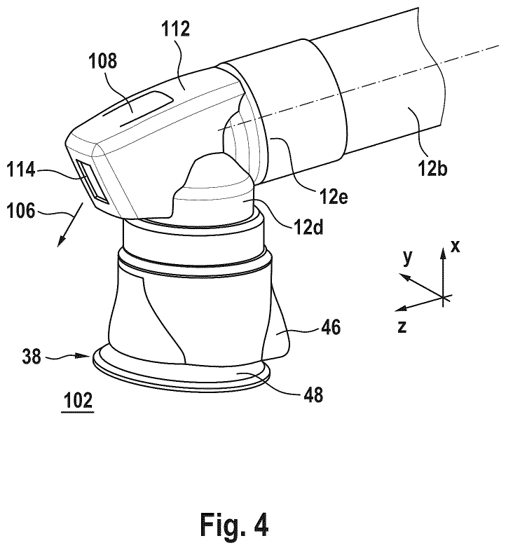

When the light emitting unit 100 is attached to the tool housing 12, preferably a contact surface of the external casing 112 of the light emitting unit 100 is in full contact with a respective external surface of the tool housing 12, i.e., the entire contact surface of the external casing 112 lies fully on a correspondingly shaped surface of the tool housing 12. Preferably, the contact surface of the external casing 112 has a three-dimensional extension. When the contact surface of the external casing 112 of the light emitting unit 100 and of the tool housing 12 enter into mutual contact, the position of the light emitting unit 100 in respect to the tool housing 12 is defined in at least two planes extending perpendicular to each other, for instance in an xy-plane and an xz-plane of a cartesian coordinate system (see FIG. 4). Preferably, the contact surfaces are designed such that the position of the light emitting unit 100 in respect to the tool housing 12 is defined in all three planes xy, xz and yz, extending perpendicular to each other, when the contact surfaces of the external casing 112 of the light emitting unit 100 and of the tool housing 12 enter into mutual contact.

It is suggested that the three-dimensional form of the external casing 112 of the light emitting unit 100 is adapted to the outer shape of a part of the tool housing 12 to which the light emitting unit 100 is releasable attachable in such a manner that the external casing 112 is flush with the adjacent surface of the tool housing 12 when the light emitting unit 100 is attached to the tool housing 12. Alternatively, it is suggested that the three-dimensional form of at least one side of the outer casing 112 of the light emitting unit 100 continues the course and/or the extension of an adjacent surface of the tool housing 12, preferably without step and/or kink. For instance, the front part of the tool housing 12 may have an indentation, an inward bulge or a recess (see FIG. 6). At least part of the external casing 112 of the light emitting unit 100 fits into that indentation, bulge or recess. At a position 136 a top side wall of the external casing 112 merges neatly into at least one of the adjacent surfaces of the tool housing 12 without steps and kinks.

The light emitting unit 100 may comprise an acceleration sensor 138 (see FIG. 6) configured to sense vibrations of the power tool 10 and to determine an operation state of the power tool 10 depending on the magnitude of the sensed vibrations, when the light emitting unit 100 is attached to the tool housing 12. The sensor can be configured to detect a turned-on condition and/or a turned-off condition of the power tool 10. Operation of the tool motor 24 and rotation of the working element 38 about the rotational axis 40 of the tool shaft 36 will lead to vibrations which are transferred to the rest of the power tool 10 including the tool housing 12. At least one threshold value for the vibrations/accelerations may be defined, and the power tool 10 is considered to be in the turned-on condition if the vibrations/accelerations exceed a threshold value and to be in the turned-off condition if the vibrations/accelerations are below a threshold value. The sensed vibrations/accelerations can be filtered and the determination of the operation state can be effected based on the filtered values.

The determined operation state of the power tool can be used for many different tasks, including assessment of proper functioning of the power tool 10 and/or the motor 24, of mounting of a correct working element 38, backing pad 48 and/or polishing or sanding member, or the like. The light emitting unit 100 may be configured to automatically actuate the switching element 108 in order to switch the light emitting unit 100 between the turned-on condition and the turned-off condition, depending on the magnitude of the sensed vibrations. Thus, the sensed vibrations/accelerations and/or the determined operation state of the power tool 10 may be used for turning on or off the at least one light source 104 of the light emitting unit 100. This has the advantage that the working area 102 is automatically illuminated upon activation and intended use of the power tool 10. Then, after turning off the power tool 10, the illumination of the working area 102 is also turned off. Activation and/or deactivation of the light sources 104 can be effected with a time delay after the vibrations/accelerations exceeding or falling below the threshold value and/or after the detection of a certain operation state of the power tool 10.

Finally, it is suggested that the light emitting unit 100 comprises a radio communication device 140 (see FIG. 6) configured to transmit radio signals 142 representative of an operation state of the power tool 10. The radio signals 142 may be received by external or remote components, for instance a dust suction device or vacuum cleaner (not shown), which is used for aspiring dust laden air from a sanding power tool 10. The radio signals 142 may serve for activating and deactivating the dust suction device or the vacuum cleaner and/or for increasing or decreasing the speed of a motor of a vacuum generation unit of the dust suction device or the vacuum cleaner.

For instance, upon receipt of a radio signal 142 from the light emitting unit 100 indicating an activation of the power tool 10, the dust suction device is automatically turned on. A suction hose of the dust suction device may be attached to a suction opening of the sanding power tool 10 so that dust laden air from the working area 102 of the power tool 102 is aspired. Similarly, when the power tool 10 is turned off again, the suction device receives a respective radio signal 142 and is also automatically turned off. Turning off the suction device is preferably effected with a time delay in respect to the receipt of the respective radio signal 142 indicating the turning off of the power tool 10. Additionally or alternatively, the radio signal 142 indicating the turning off of the power tool 10 may be transmitted with a time delay in respect to the turning off of the power tool 10. The radio signal 142 and the data contained therein may be in any communication standard known today or yet to be developed, including WiFi, BlueTooth, ZigBee or the like. The dust suction device or the vacuum cleaner is equipped with a corresponding radio communication device configured to receive the radio signals 142 from the radio communication device 140 of the light emitting unit 100.

Preferably, the radio communication link between the radio communication device 140 of the light emitting unit 100 and the corresponding radio communication device of the dust suction device or the vacuum cleaner is strictly unidirectional, at least during intended use and transmission of useful data. However, it is conceivable that during set-up and configuration of the radio communication link configuration data is transmitted bi-directionally the radio communication link.

1. Hand-held power tool (10) comprising a tool housing (12) and a motor (24) located therein and a tool shaft (36) having a rotational axis (40), actuated by the motor (24) when in operation, in order to make the tool shaft (36) perform a rotational movement about its rotational axis (40), and further comprising a working element (38) attached to a distal end of the tool shaft (36) and performing a working movement about the rotational axis (40) of the tool shaft (36) during operation of the motor (24), and a light emitting unit (100) releasably attached to the tool housing (12) in order to illuminate a working area (102) which the working element (38) works during intended use of the power tool (10),
characterized in that the light emitting unit (100) comprises
at least one light source (104) adapted for emitting light towards the working area (102), when the light emitting unit (100) is attached to the tool housing (12),
a switching element (108) adapted for switching the light emitting unit (100) between a turned-on condition, in which the at least one light source (104) emits light, and a turned-off condition, in which the at least one light source (104) does not emit light,
an energy storage device (110) adapted for storing electric energy and for supplying the electric energy to the at least one light source (104) when the light emitting unit (100) is in its turned-on condition, and
an external casing (112), in which the at least one light source (104) is located in a manner as to emit light in a direction (106) towards the working area (102), when the light emitting unit (100) is attached to the tool housing (12), in which the switching element (108) is located in a manner operable from outside the external casing (112) by a user of the power tool (10), when the light emitting unit (100) is attached to the tool housing (12), and in which the energy storage device (110) is located,
wherein the light emitting unit (100) is operable as a self-sufficient unit after detachment and removal from the tool housing (12), in order to illuminate areas outside the working area (102) of the working element (38) and/or to illuminate the working area (102) from other incidence directions or angles differing from the point of view of the user during intended use of the power tool (10).

2. Power tool (10) according to claim 1, wherein the at least one light source (104) comprises a light emitting diode and/or the energy storage device (110) comprises a battery, including a rechargeable battery.

3. Power tool (10) according to claim 1, wherein the external casing (112) of the light emitting unit (100) is made of a plastic material and/or the external casing (112) of the light emitting unit (100) is shaped in correspondence to a part of the tool housing (12) in order to realize a releasable attachment (116) of the light emitting unit (100) to the tool housing (12) by means of a form fit connection between the external casing (112) of the light emitting unit (100) and the correspondingly shaped part of the tool housing (12).

4. Power tool (10) according to claim 3, wherein the external casing (112) of the light emitting unit (100) is shaped in correspondence to a front part (44) of the tool housing (12) and the releasable attachment (116) of the light emitting unit (100) to the tool housing (12) is realized by means of a form fit connection between the external casing (112) of the light emitting unit (100) and the front part (44) of the tool housing (12).

5. Power tool (10) according to claim 1, wherein, when the light emitting unit (100) is attached to the tool housing (12), a contact surface of the external casing (112) of the light emitting unit (100) is in full contact with a respective external surface of the tool housing (12).

6. Power tool (10) according to claim 5, wherein the contact surface has a three-dimensional extension.

7. Power tool (10) according to claim 3, wherein the releasable attachment (116) of the light emitting unit (100) to the tool housing (12) is realized by means of a snap-action connection (118, 120) between the external casing (112) of the light emitting unit (100) and the tool housing (12).

8. Power tool (10) according to claim 3, wherein the releasable attachment (116) of the light emitting unit (100) to the tool housing (12) is realized by means of interacting magnetic elements (122, 124) provided in or on the external casing (112) of the light emitting unit (100) and in or on the tool housing (12).

9. Power tool (10) according to claim 8, wherein the magnetic elements (122, 124) comprise one or more permanent magnets (122, 124) and/or one or more ferromagnetic elements.

10. Power tool (10) according to claim 1, wherein a three-dimensional form of the external casing (112) of the light emitting unit (100) is adapted to an outer shape of a part of the tool housing (12) to which the light emitting unit (100) is releasable attachable in such a manner that the external casing (112) of the light emitting unit (100) is flush with at least some of the adjacent surfaces of the tool housing (12), when the light emitting unit (100) is attached to the tool housing (12).

11. Power tool (10) according to claim 1, wherein the light emitting unit (100) comprises an acceleration sensor (138) configured to sense vibrations of the power tool (10) and to determine an operation state of the power tool (10) depending on the magnitude of the sensed vibrations, when the light emitting unit (100) is attached to the tool housing (12), including to automatically actuate the switching element (108) in order to switch the light emitting unit (100) between the turned-on condition and the turned-off condition, depending on the magnitude of the sensed vibrations.

12. Power tool (10) according to claim 11, wherein the light emitting unit (100) comprises a radio communication device (140) configured to transmit radio signals (142) representative of the determined operation state of the power tool (10).

13. Light emitting unit (100) comprising
at least one light source (104) adapted for emitting light,
a switching element (108) adapted for switching the light emitting unit (100) between a turned-on condition, in which the at least one light source (104) emits light, and a turned-off condition, in which the at least one light source (104) does not emit light,
an energy storage device (110) adapted for storing electric energy and for supplying the electric energy to the at least one light source (104), when the light emitting unit (100) is in its turned-on condition, and
an external casing (112), in which the at least one light source (104) is located in a manner as to emit light towards an area outside the external casing (112), in which the switching element (108) is located in a manner operable from outside the external casing (112) by a user, and in which the energy storage device (110) is located,
wherein the light emitting unit (100) is operable as a self-sufficient unit,
characterized in that
the light emitting unit (100) is configured for releasable attachment to a tool housing (12) of a power tool (10) according to one of the preceding claims,
the at least one light source (104) is adapted for emitting light in a direction (106) towards a working area (102), which a working element (38) of the power tool (10) works during intended use of the power tool (10), when the light emitting unit (100) is attached to the tool housing (12),
the at least one light source (104) is located in the external casing (112) in a manner as to emit light in the direction (106) towards the working area (102) when the light emitting unit (100) is attached to the tool housing (12), and
the switching element (108) is located in the external casing in a manner operable from outside the external casing (112) by a user of the power tool (10), when the light emitting unit (100) is attached to the tool housing (12),
wherein the light emitting unit (100) is operable as a self-sufficient unit after detachment and removal from the tool housing (12), in order to illuminate areas outside the working area (102) of the working element (38) and/or to illuminate the working area (102) from other incidence directions and/or angles differing from the point of view of the user of the power tool (10) during intended use of the power tool (10).

14. Light emitting unit (100) according to claim 13, wherein a three-dimensional form of the external casing (112) of the light emitting unit (100) is adapted to an outer shape of a part, in particular a front part (44), of the tool housing (12) to which the light emitting unit (100) is releasable attachable in such a manner that the external casing (112) of the light emitting unit (100) is flush with at least some of the adjacent surfaces of the tool housing (12) when the light emitting unit (100) is attached to the tool housing (12).

15. Light emitting unit (100) according to claim 13, wherein the light emitting unit (100) comprises a magnetic element (122) or part (118, 120) of a snap-action connection in order to realize a releasable attachment (116) of the light emitting unit (100) to the tool housing (12) and/or wherein the light emitting unit (100) comprises an acceleration sensor (138) configured to sense vibrations of the power tool (10) and determine an operation state of the power tool (10) depending on the magnitude of the sensed vibrations, when the light emitting unit (100) is attached to the tool housing (12), and/or wherein the light emitting unit (100) comprises a radio communication device (140) configured to transmit radio signals (142) representative of a determined operation state of the power tool (10).

16. Power tool (10) according to claim 2, wherein the external casing (112) of the light emitting unit (100) is made of a plastic material and/or the external casing (112) of the light emitting unit (100) is shaped in correspondence to a part of the tool housing (12) in order to realize a releasable attachment (116) of the light emitting unit (100) to the tool housing (12) by means of a form fit connection between the external casing (112) of the light emitting unit (100) and the correspondingly shaped part of the tool housing (12).

17. Power tool (10) according to claim 4, wherein the releasable attachment (116) of the light emitting unit (100) to the tool housing (12) is realized by means of a snap-action connection (118, 120) between the external casing (112) of the light emitting unit (100) and the tool housing (12).

18. Power tool (10) according to claim 4, wherein the releasable attachment (116) of the light emitting unit (100) to the tool housing (12) is realized by means of interacting magnetic elements (122, 124) provided in or on the external casing (112) of the light emitting unit (100) and in or on the tool housing (12).

19. Power tool (10) according to claim 2, wherein a three-dimensional form of the external casing (112) of the light emitting unit (100) is adapted to an outer shape of a part of the tool housing (12) to which the light emitting unit (100) is releasable attachable in such a manner that the external casing (112) of the light emitting unit (100) is flush with at least some of the adjacent surfaces of the tool housing (12), when the light emitting unit (100) is attached to the tool housing (12).

20. Power tool (10) according to claim 2, wherein the light emitting unit (100) comprises an acceleration sensor (138) configured to sense vibrations of the power tool (10) and to determine an operation state of the power tool (10) depending on the magnitude of the sensed vibrations, when the light emitting unit (100) is attached to the tool housing (12), including to automatically actuate the switching element (108) in order to switch the light emitting unit (100) between the turned-on condition and the turned-off condition, depending on the magnitude of the sensed vibrations.
